(19) United States
(12) Patent Application Publication
(10) Pub. No.: US 2024/0373081 A1
(43) Pub. Date: Nov. 7, 2024

(54) METHOD FOR CARRIAGE OF TIME-TRIGGERED SPATIAL HAPTIC EFFECTS IN THE INTERCHANGE FORMAT

(71) Applicant: Tencent America LLC, Palo Alto, CA (US)

(72) Inventor: Iraj SODAGAR, Los Angeles, CA (US)

(73) Assignee: Tencent America LLC, Palo Alto, CA (US)

(21) Appl. No.: 18/767,085

(22) Filed: Jul. 9, 2024

Related U.S. Application Data
(60) Provisional application No. 63/525,928, filed on Jul. 10, 2023.
(60) Provisional application No. 63/252,926, filed on Oct. 6, 2021.
(60) Provisional application No. 63/525,924, filed on Jul. 10, 2023.
(60) Provisional application No. 63/525,920, filed on Jul. 10, 2023.

(51) Int. Cl. H04N 21/43; H04N 21/435; H04N 21/81

(52) U.S. Cl. CPC H04N 21/43074; H04N 21/435; H04N 21/81

(57) ABSTRACT

A method of signaling a haptic java script object notation (JSON) interchange file format (HJIF) file includes processing the HJIF file into a binary file format for distribution in a bitstream, wherein the HJIF file comprises a plurality of time-triggered spatial haptic effects, wherein at least one time-triggered spatial haptic effect from the plurality of special haptic effects varies along a spatial axis, wherein the at least one time-triggered spatial haptic effect is associated with a first parameter defining a trigger time, and wherein a renderer is configured to render at least one time-triggered spatial haptic effect in accordance with the trigger time.

### CROSS-REFERENCE TO RELATED APPLICATIONS

This application claims priority from U.S. Provisional Application No. 63/525,928, filed on Jul. 10, 2023, U.S. Provisional Application No. 63/525,926, filed on Jul. 10, 2023, U.S. Provisional Application No. 63/525,924, filed on Jul. 10, 2023, and U.S. Provisional Application No. 63/525,920, filed on Jul. 10, 2023, the disclosures of each of which are incorporated herein by reference in their entirety.

### FIELD

The embodiments of the present disclosure relate a method for carriage of time-triggered spatial haptic effects in the interchange format.

### BACKGROUND

The use of haptics has become a part of multimedia presentation. In such an application, haptic signals are delivered to a device or wearable hardware, where the user feels the haptic sensations during the use of the application. Recently, MPEG has started working on a compression standard for haptics.

The haptic Committee Draft includes one java script object notation (JSON) format and one binary format. The current JSON format, as known as the haptics interchange format, carries temporal and spatial haptic effects. But the spatial haptic effects are constant in time, and thus, non-time-varying. Furthermore, the current JSON format does not include any timed packetization.

### SUMMARY

According to an aspect of the disclosure, a method of signaling a haptic java script object notation (JSON) interchange file format (HJIF) file, comprises: processing the HJIF file into a binary file format for distribution in a bitstream, wherein the HJIF file comprises a plurality of time-triggered spatial haptic effects, wherein at least one time-triggered spatial haptic effect from the plurality of special haptic effects varies along a spatial axis, wherein the at least one time-triggered spatial haptic effect is associated with a first parameter defining a trigger time, and wherein a renderer is configured to render at least one time-triggered spatial haptic effect in accordance with the trigger time.

According to an aspect of the disclosure, a method of signaling a haptic java script object notation (JSON) interchange file format (HJIF) file comprises: processing the HJIF file into a binary file format for distribution in a bitstream, wherein the HJIF file comprises a data hierarchy that specifies (i) a haptic perception at first level of the data hierarchy, (ii) one or more haptic channels corresponding to the haptic perception at a second level of the data hierarchy, and (iii) one or more haptic bands corresponding to the one or more haptic channels at a third level of the data hierarchy, wherein the first level in the data hierarchy is higher than the second level in the data hierarchy, and the second level in the data hierarchy is higher than the third level in the data hierarchy, wherein the HJIF file further comprises a plurality time packets, wherein each time packet comprises a time parameter and one or more haptic effects, and wherein a renderer is configured to render each of the one or more haptic effects in accordance with the time parameter of each time packet.

According to an aspect of the disclosure, a method of decoding a haptic java script object notation (JSON) interchange file format (HJIF) file, comprises: receiving a bitstream; decoding the bitstream to extract the HJIF file; and rendering a plurality of time-triggered spatial haptic effects included in the HJIF file, wherein at least one time-triggered spatial haptic effect from the plurality of special haptic effects varies along a spatial axis, wherein the at least one time-triggered spatial haptic effect is associated with a first parameter defining a trigger time, and wherein the at least one time-triggered spatial haptic effect is rendered in accordance with the trigger time.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIGS. 3 and 4 are an illustration of a haptic codec architecture, according to embodiments.

FIG. 5 illustrates a JSON format data hierarchy.

FIG. 6 illustrates an example data hierarchy, according to embodiments.

FIG. 7 illustrates an example data hierarchy, according to embodiments.

FIG. 8 illustrates an example data hierarchy, according to embodiments.

FIG. 9 illustrates an example flow chart of a process for rendering time-triggered spatial haptic effects.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

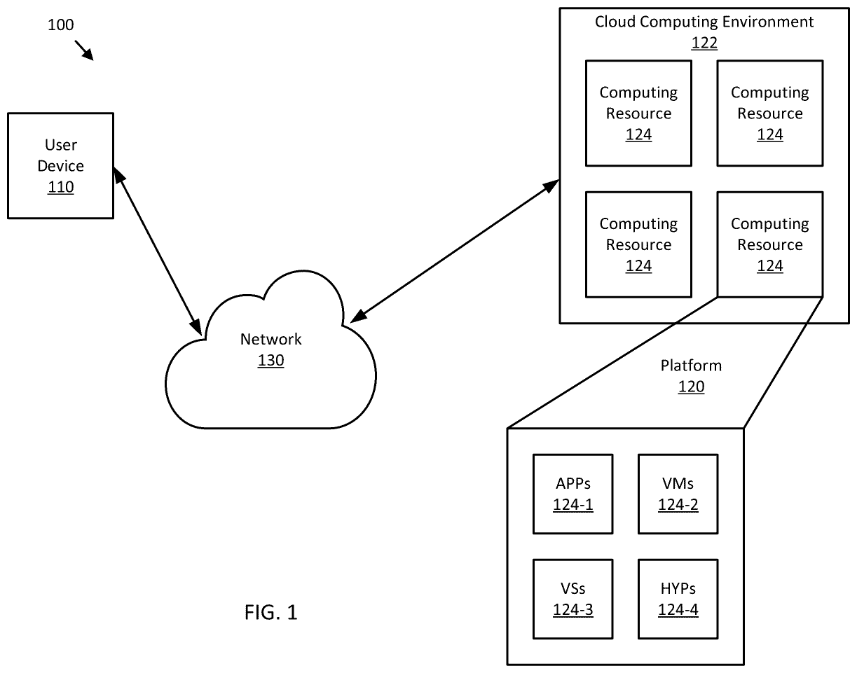

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

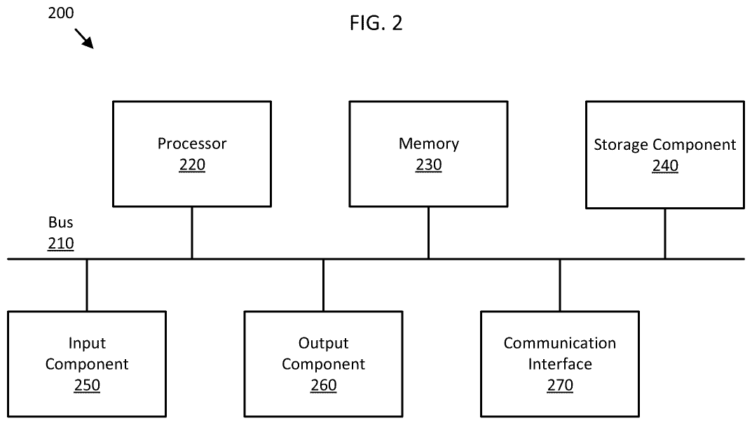

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

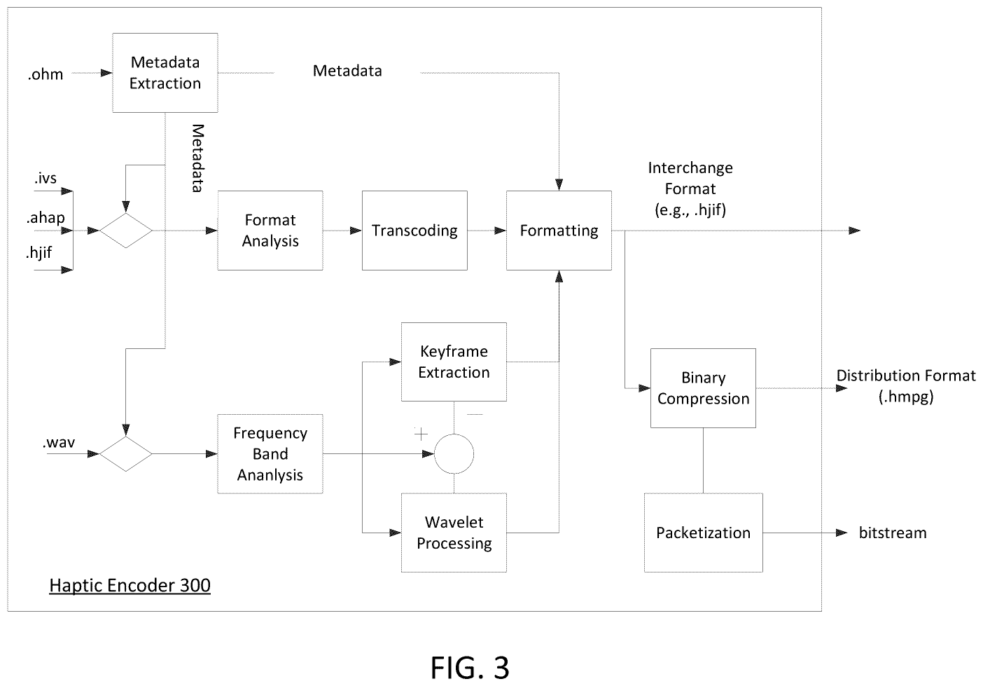

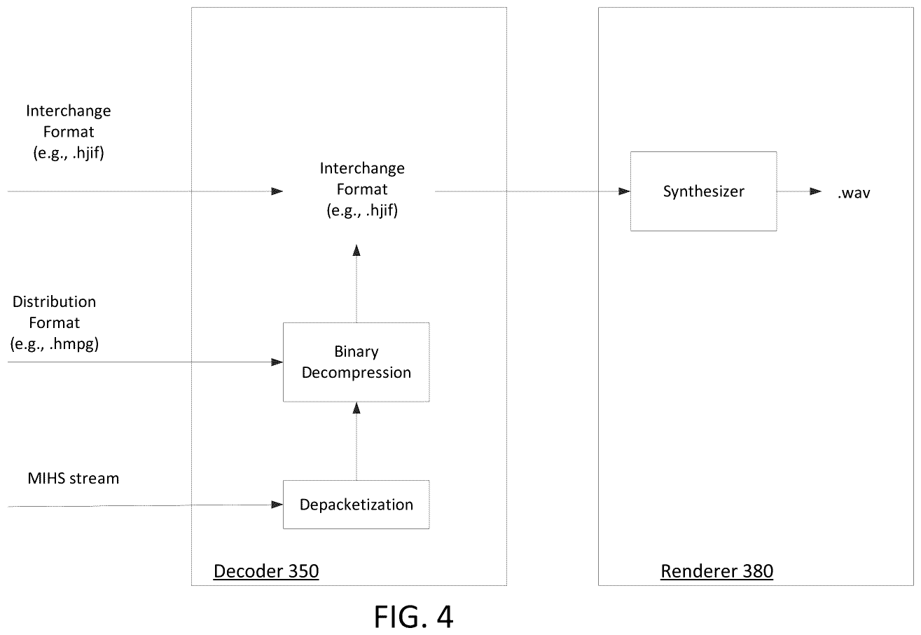

With reference to FIGS. 3-4, an embodiment of the present disclosure for implementing haptic encoder 300 and haptic decoder 350 are described.

As shown in FIG. 3, the haptic encoder 300 may receive both descriptive and waveform haptic data. Thus, the haptic encoder 300 may be able to process three types of input files: .ohm metadata files (Object Haptic Metadata—Text file format for haptics metadata), descriptive haptics files (.ivs, .ahap, and .hjif) or waveform PCM files (.wav). An example of descriptive data may include .ahap (Apple Haptic and Audio Pattern-JSON-like file format that specifies a haptic pattern) from Apple (representing the expected haptic output by a set of modulated continuous signals and a set of modulated transients parametrized), .ivs from Immersion (representing the expected haptic output by a set of basis effects parametrized by a set of parameters), or .hjif (Haptics JSON Interchange Format) the proposed MPEG format. An example of the waveform pulse-code modulation (PCM) signals may include .ohm input files that include metadata information.

According to an embodiment, the haptic encoder 300 may process the two types of input files differently. For descriptive content, the haptic encoder 300 may analyze the input semantically to transcode (if necessary) the data into the proposed coded representation.

According to an embodiment, the .ohm metadata input file may include a description of the haptic system and setup. In particular, it may include the name of each associated haptic file (either descriptive or PCM) along with a description of the signals. It also provides a mapping between each channel of the signals and the targeted body parts on the user's body. For the .ohm metadata input file, the haptic encoder performs metadata extraction by retrieving the associated haptic files from the URI and encodes it based on its type and by extracting the metadata from the .ohm file and maps it to metadata information of the data model.

According to an embodiment, descriptive haptics files (e.g., .ivs, .ahap, and .hjif) may be encoded through a simple process. The haptic encoder 300 first identifies specifically the input format. If the input format is a .hjif file, then no transcoding is necessary, the file can be further edited, compressed into the binary format and eventually packetized into an MIHS stream. If .ahap or .ivs input files are used, a transcoding is necessary. The haptic encoder 300 first analyses the input file information semantically and transcodes it to be formatted into a selected data model. After transcoding, the data can be exported as the .hjif file, a .hmpg binary file or an MIHS stream.

According to an embodiment, the haptic encoder 300 may perform signal analysis to interpret the signal structure of the .wav files and convert it into the proposed encoded representation. For waveform PCM content, the signal analysis process may be split into two sub-processes by the haptic encoder 300. After performing a frequency band decomposition on the signal, at a first sub-process, low frequencies may be encoded using a keyframe extraction process. The low frequency band(s) may then be reconstructed and the error between this signal and the original low frequency signal may be computed. This residual signal may then be added to the original high frequency band(s), before encoding using Wavelet Transforms, the encoding using Wavelet Transforms being the second sub-process. According to an embodiment, when several low frequency bands are used, the residual errors from all the low frequency bands are added to the high frequency band before encoding. In embodiment when several high frequency bands are used, the residual errors from the low frequency band(s) are added to the first high frequency band before encoding.

According to an embodiment, keyframe extraction includes taking the lower frequency band from the frequency band decomposition and analysing its content in the time domain. According to an embodiment, wavelet processing may include taking the high frequency band from the frequency band decomposition and the low frequency residual, and splitting it into blocks of equal size. These signal blocks of equal size are then analysed in a psychohaptic model. The lossy compression may be applied by wavelet transforming the block and quantizing it, aided by the psychohaptic model. In the end, each block is then saved into a separate effect in a single band, which is done in the formatting. The binary compression may apply lossless compression using the appropriate coding techniques, e.g., the Set partitioning in hierarchical trees (SPIHT) algorithm and Arithmetic Coding (AC).

As shown in FIG. 3, the haptic encoder 300 may be configured to encode descriptive and quantized haptic data and may output three types of formats—an interchange format (.hjif), a binary compressed format (.hmpg), and a streaming format (e.g., MPEG immersive haptic stream (MIHS)). The .hjif format is a human-readable format based on JSON and can easily be parsed and manually edited which makes it an ideal interchange format, especially when designing/creating content. For distribution purposes, the .hjif data can be compressed into a more memory efficient binary .hmpg bitstream. This compression may be lossy, with different parameters impacting the encoding depth of amplitude and frequencies composing the bitstream. For streaming purposes, the data can be compressed and packetized into a MPEG-I haptic stream (MIHS). The above-mentioned three formats have complementary purposes and a lossy one-to-one conversion may be operated between them.

As shown in FIG. 4, the haptic decoder 350 may take as input either a .hmpg compressed binary file format or an MIHS bitstream. the haptic decoder 350 may output a .hjif interchange format that can be used directly for rendering. The two input formats may go through a binary decompression to extract both the metadata and the data itself from the file and map it to the selected data structure. Then, the data can be exported in the .hjif format to the haptic renderer 380.

As shown in FIG. 4, the renderer 380 comprises a synthesizer. The synthesizer may render haptic data from a .hjif input file into a PCM output file. The rendering and/or synthesizing is informative. According to an embodiment, the synthesizer parses the input files and performs the high-level synthesis distribution between vectorial, wavelets, etc. The synthesis process then goes down to the Band component of the codec in which a synthesis process is called. Then all the bands of a given channel are mixed by a simple addition operator to recreate the desired haptic signal.

Embodiments of the present disclosure are directed to a method for the carriage of time-triggered spatial haptic effects in the interchange format. In one or more examples, the spatial haptic effect is defined for spatial perceptual modalities, e.g., the haptic effect changes by distance from an origin. The HJIF format supports such an effect.

In one or more examples, we define a time-triggered haptic effect as a haptic signal that varies in space. For example, the effect is associated with a spatial axis, and also may have a trigger time (e.g., the effect is triggered at a certain time).

According to one or more embodiments, a time-triggered spatial haptic effect may have two parameters: (i) the position P, which corresponds to a distance from the spatial origin where the haptic effect becomes active, and (ii) a trigger time, T, which corresponds to a temporal offset from time 0 (e.g., the beginning of the playback) when the haptic effect is rendered.

In one or more examples, an optional parameter for a spatial position is provided in an HJIF file as illustrated in Table 1.

TABLE 1

| Property | Type | Default | Description | Required |
|---|---|---|---|---|
| id | Integer | N/A | Unique ID of an effect. This | No |
| | | | attribute is only required for | |
| | | | library effects and “Reference” | |
| | | | effects. For “Reference” | |
| | | | effects, it corresponds to the ID | |
| | | | of the library effect being | |
| | | | referenced. The value shall be | |
| | | | greater or equal to 0. The ID is | |
| | | | unique among all effect IDs in | |
| | | | this haptic experience. | |
| effect_type | enum<string> | Basis | Indicates the type of haptic | |
| | | | effect. Effect-type value equals | |
| | | | one of: “Basis”, “Composite” | |
| | | | and “Reference”. | |
| semantic | String | N/A | Semantic keywords included | No |
| keywords | | | with the effect. | |
| position | Integer | 0 | Indicates the temporal or spatial | |
| | | | position of the effect according | |
| | | | to perception modalities. In the | |
| | | | case of temporal, | |
| | | | position/timescale is the | |
| | | | temporal position in seconds. | |
| | | | The value must be greater or | |
| | | | equal to 0. | |
| trigger_time | Integer | 0 | Indicates the temporal offset for | No |
| | | | spatial effect to be rendered. | |
| | | | The trigger time/timescale | |
| | | | defines the offset in seconds. | |
| | | | The value must be greater or | |
| | | | equal to 0. | |
| | | | This value is ignored for | |
| | | | temporal effects. | |
| phase | Number | 0 | Phase of the effect. The value | Yes |
| | | | may be in the range [0, 2π] | |
| base_signal | enum<string> | Sine | Indicates the type of the | No |
| | | | waveform signal. This property | |
| | | | is required for vectorial wave | |
| | | | bands. Possible values are: | |
| | | | “Sine” | |
| | | | “Square” | |
| | | | “Triangle” | |
| | | | “SawToothUp” | |
| | | | “SawToothDown” | |
| composition | array<MPEG_haptics.effect> | | This attribute may only be used | |
| | | | with composite effects. It | |
| | | | contains a list of effects. This | |
| | | | type of effect does not directly | |
| | | | contain keyframes. | |
| Keyframes | array<MPEG_haptics.effect> | N/A | List of | |
| | | | MPEG_haptics.keyframes. This | |
| | | | property is required for basis | |
| | | | effects. If the keyframes array | |
| | | | is empty, the effect does not | |
| | | | contain haptic data. | |

In one or more examples, a trigger_time may be defined to be the offset for all effects (e.g., both temporal and spatial), where the position may be used as the spatial offset for the spatial effects, as illustrated in Table 2.

TABLE 2

| Property | Type | Default | Description | Required |
|---|---|---|---|---|
| Id | Integer | N/A | Unique ID of an effect. This | No |
| | | | attribute is only required for | |
| | | | library effects and “Reference” | |
| | | | effects. For “Reference” | |
| | | | effects, it corresponds to the ID | |
| | | | of the library effect being | |
| | | | referenced. The value shall be | |
| | | | greater or equal to 0. The ID is | |
| | | | unique among all effect IDs in | |
| | | | this haptic experience. | |
| effect_type | enum<string> | Basis | Indicates the type of haptic | |
| | | | effect. Effect-type value equals | |
| | | | one of: “Basis”, “Composite” | |
| | | | and “Reference”. | |
| semantic | String | N/A | Semantic keywords included | No |
| keywords | | | with the effect. | |
| trigger_time | Integer | 0 | Indicates the temporal offset | No |
| | | | for spatial effect to be rendered. | |
| | | | The trigger time/timescale | |
| | | | defines the offset in seconds. | |
| | | | The value must be greater or | |
| | | | equal to 0. | |
| | | | This value is ignored for | |
| | | | temporal effects. | |
| Position | Integer | 0 | Indicates distance from the | |
| | | | origin for the spatial perception | |
| | | | modalities. In the case of | |
| | | | temporal perceptions, this value | |
| | | | may be ignored. The value | |
| | | | must be greater or equal to 0. | |
| Phase | Number | 0 | Phase of the effect. The value | Yes |
| | | | may be in the range [0, 2π] | |
| base_signal | enum<string> | Sine | Indicates the type of the | No |
| | | | waveform signal. This property | |
| | | | is required for vectorial wave | |
| | | | bands. Possible values are: | |
| | | | “Sine” | |
| | | | “Square” | |
| | | | “Triangle” | |
| | | | “SawToothUp” | |
| | | | “SawToothDown” | |
| Composition | array<MPEG_haptics.effect> | | This attribute may only be used | |
| | | | with composite effects. It | |
| | | | contains a list of effects. This | |
| | | | type of effect does not directly | |
| | | | contain keyframes. | |
| Keyframes | array<MPEG_haptics.effect> | N/A | List of | |
| | | | MPEG_haptics.keyframes. | |
| | | | This property is required for | |
| | | | basis effects. If the keyframes | |
| | | | array is empty, the effect does | |
| | | | not contain haptic data. | |

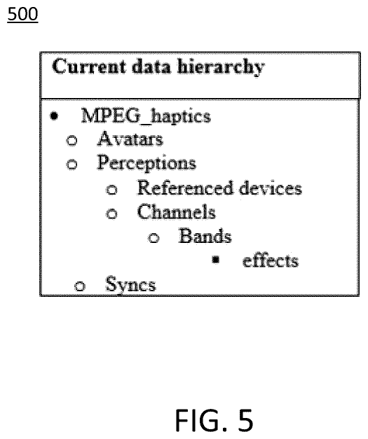

The embodiments of the present disclosure are further directed to a method for the packetization of haptic effects in the haptic interchange format. As understood by one of ordinary skill in the art, the haptics interchange format (.hjif) does not specify a time packetization of haptic effects. Instead, this interchange format specifies a non-timed JSON format in accordance with the data hierarchy 500 illustrated in FIG. 5. According to the data hierarchy 500, all the data structures are in a single time scale.

In one or more examples, haptic avatars may be used as body representations. Haptic avatars define different types of avatars and allow to reference a custom 3D mesh from a companion file. Each haptic perception of the experience is associated with a haptic avatar, which allows spatialization of haptic effects at the haptic channel level. The same avatar can be used by multiple perceptions. Using a 3D mesh allows to provide high resolution and accuracy with variable vertex density depending on the application. For instance, the density can be representative of the spatial acuity of a specific perception modality.

Table 3 illustrates example properties of the haptic avatar.

TABLE 3

| Property | Description |
|---|---|
| Id | Unique identifier of the avatar. |
| Lod | If the avatar uses a mesh with several levels of detail (LODs), |
| | this indicates which LOD should be used for the avatar. |
| Type | Type of haptic perception represented by the avatar. It is |
| | related to the spatial acuity of the corresponding haptic |
| | modality. The avatar type may be: |
| | Vibration: for an avatar representative for vibrotactile signals. |
| | Pressure: for an avatar representative for pressure signals. |
| | Temperature: for an avatar representative for temperature |
| | signals. |
| | Custom: for a custom avatar representative for the application. |
| | The mesh is provided as a companion file using the mesh |
| | URI. The definition of custom mesh is out of of the scope of |
| | this document. |
| Mesh | URI to access the associated 3D mesh file. The URI must |
| | follow the syntax defined in RFC3986 |

In one or more examples, a haptic perception is a haptic signal associated with a specific perception modality. The format supports modalities encoded in function of the time (Pressure, Acceleration, Velocity, Position, Temperature, Vibrotactile, Water, Wind, Force, Electrotactile) or space (VibrotactileTexture, Stiffness and Friction). The list of supported modalities is provided in Table 5 with the corresponding units. For each haptic perception, metadata information is provided on the modality, the corresponding avatar representation, and technical characteristics of targeted or compatible haptic devices. The data associated to a perception may contain multiple channels. A channel is associated to a body location and usually corresponds to a haptic device. For instance: a vibrotactile suit with 16 channels corresponding to 16 “Vibrotactile” actuators or a gamepad with one “Force” feedback trigger.

A haptic perception may contain an effect library. Table 4 illustrates example properties of a haptic perception.

TABLE 4

| Property | Description |
|---|---|
| Id | Unique identifier of the perception. |
| perception | Type of perception modality of the haptic signal. |
| modality | |
| Description | Description of the haptic data contained in the perception. |
| avatar id | Unique identifier of the associated avatar, defined in the |
| | data structure. |
| effect library | List of haptic effects. Effects from the library shall have an |
| | id and may be referenced directly in a Band. |
| reference | List of targeted haptic reference devices or actuators used |
| devices | for this haptic perception. |
| Channels | List of haptics channels composing this perception. |
| unit | Exponent of the powers of 10 for the SI unit identifying the |
| exponent | space of representation of the independent variable. |
| | This property specifies which measurement unit is used to |
| | encode the given perception. By default, the considered |
| | value is −3. |
| | For example, if the perception modality is set to vibration |
| | and this exponent is set to −3, the perception experience is |
| | encoded in milliseconds. |
| perception | Exponent of the powers of 10 for the SI unit measure of the |
| unit | dependent variable. This property specifies which |
| exponent | measurement unit is used to output the given perception. By |
| | default, the considered value is 0. |
| | For example, if the perception modality is set to stiffness |
| | and this exponent is set to 0, the perception experience is |
| | encoded in Newton. |

In one or more examples, a haptic experience may be defined with a reference setup to validate the experience or with a number of specific targeted haptic devices (e.g., referenced device). If the experience is played back on different devices with different capabilities, the associated encoded signal may have to be rendered differently. To perform such adaptation, the capabilities of the original device(s) (reference or compatible devices) must be known. For this purpose, each haptic perception defines a list of reference devices (with their detailed characteristics) and each haptic channel may reference the corresponding device. A haptic reference device is described through a list of characteristics, including the type of device, the frequency range of the device, the maximum voltage of the device and many other properties. An example list of properties is specified in Table 5.

TABLE 5

| Property | Description |
|---|---|
| Id | Unique identifier of the device. |
| Name | Name of the device. |
| body part | Binary mask specifying the location of the device or |
| mask | actuator on the body based on the body segmentation. |
| maximum | Maximum frequency of the actuator (Hz). |
| frequency | |
| minimum | Minimum frequency of the actuator (Hz). |
| frequency | |
| resonance | Resonance frequency of the actuator (Hz). |
| frequency | |
| maximum | Maximum amplitude value of the targeted device according |
| amplitude | to the perception modality. |
| | For instance, it relates to the maximum acceleration speed if |
| | the perception modality is the acceleration.. |
| Impedance | Impedance of the actuator (Ω). |
| maximum | Maximum voltage of the actuator (V). |
| voltage | |
| maximum | Maximum current of the actuator (A). |
| current | |
| maximum | Maximum displacement of the actuator (mm). |
| displacement | |
| Weight | Weight of the device (Kg). |
| Size | Indicates the size of the device (mm). |
| Custom | User-defined data. This parameter may be used to specify |
| | additional properties of the targeted device. |
| Type | Type of actuator. Possible types are: |
| | LRA, |
| | VCA |
| | ERM |
| | Piezo |
| | Unknown (for other modalities) |

In one or more examples, haptic signals may be encoded on multiple channels. For example, a haptic channel defines a signal to be rendered at a specific body location with a dedicated actuator/device. Metadata stored at the channel level includes information such as the gain associated to the channel, the mixing weight, the desired body location of the haptic feedback and optionally the reference device and/or a direction. Additional information such as the desired sampling frequency or sample count can also be provided. Finally, the haptic data of a channel is contained in a set of haptic bands defined by their frequency range. The list of properties of a haptic channel is detailed in Table 6.

TABLE 6

| Property | Description |
|---|---|
| id | Unique identifier of the channel. |
| description | Description of the channel. |
| reference device | Targeted reference device from the list defined in the perception. |
| id | |
| gain | Gain associated with the channel to adapt the normalized encoded data |
| | values to a typical device, according to: |
| | V = gain * x |
| | Where x corresponds to the normalized encoded data. |
| mixing weight | Weight of the channel when mixing different channels together to |
| | produce a mixed signal. The resulting signal is given by: |
| | $V = \frac{\sum {V}_{i} * {weight}_{i}}{\sum {weight}_{i}}$ |
| | Where Vᵢ corresponds to the signal of channel i. A mixing weight of 0 |
| | indicates that the channel is not mixed. |
| body part mask | Binary mask specifying the location of the effect on the body. |
| | The binary mask 0 × 0 indicates that the body part is not specified. The |
| | application can render the effect anywhere. The mask 0 × FFFFFFFF |
| | corresponds to the full body. It means that the effect is applied on the |
| | whole body. For instance, it may be used for background effects such as |
| | the impact of an explosion. |
| actuator | Reference actuator resolution used to design the haptic experience. This |
| resolution | value linked to body part target and actuator target can be used |
| | together as an experience spatialization model on the human body. |
| body part target | Identification of a unique and/or a group of body parts on the human |
| | body semantically. |
| actuator target | List of different coordinates to target actuators on the previously |
| | identified human body parts. |
| frequency | Sampling frequency of the original encoded signal (Hz). |
| sampling | This may be used by the synthesizer to reconstruct the original signal. |
| | However, the synthesizer may sample the output signal at another |
| | sampling frequency. |
| sample count | Present if the frequency sampling value is greater than 0. It is the |
| | number of samples of the original encoded signal. This can be used along |
| | with the frequency sampling by the synthesizer to ensure that the |
| | output signal has the same size and duration as the original file. |
| vertices | List of the vertices from the avatar impacted by the effect. More |
| | precisely, it is the list of indices of the vertices from the mesh associated |
| | to the avatar of the perception. If the avatar does not specify a mesh, this |
| | field should be ignored. The vertices impacted by the effects of this |
| | channel are the body locations where the effects should be applied. |
| | The appropriate avatar representation is referenced by the avatar id |
| | indicated at the perception level. |
| bands | List of haptic bands composing the channel. A channel can include one |
| | or several bands. A band corresponds to a frequency bandwidth. |
| | If the bands array is empty, it corresponds to a channel without any |
| | haptic effect. |
| | The haptic signal of a channel may be the sum of the signals in each |
| | band. |
| direction | Specifies a spatial direction for the channel. This direction metadata |
| | should only be used with haptic modalities dependant on the space |
| | dimension (i.e. Vibrotactile Texture, Stiffness and Friction). It indicates |
| | a preferred rendering direction of the haptic perception of the targeted |
| | body part. It can be composed with X, Y and Z following the formalism |
| | for unit vectors to indicate any direction in the 3D space. Each integer |
| | value stored in this vector will be transformed from its initial range |
| | [−127; 127] to the [−1; 1] range to interpret this vector as unitary. |

In one or more examples, a haptic band describes the haptic signal of a channel in a given frequency range. Bands are defined by a type and a sequential list of haptic effects each containing a set of keyframes. Table 7 is an example list of properties of a haptic band.

TABLE 7

| Property | Description |
|---|---|
| band type | Type of data contained in the band. There are 4 types of |
| | haptics bands: Curve bands, Transient bands, Vectorial wave |
| | bands and Wavelet wave bands. For each type of band, the |
| | information it contains has a different meaning: |
| | Curve: Curve bands represent haptic signals with curves, |
| | described by a set of control points and a type of |
| | interpolation in-between |
| | Transient: Transient bands represent short momentary haptic |
| | effects of fixed duration, described with amplitude and |
| | frequency parameters. |
| | Vectorial Wave: Vectorial Wave bands represent parametric |
| | haptic effects; described by a vector of parameters including |
| | temporal or spatial position, amplitude and frequency. The |
| | model allows both amplitude and frequency modulation of the |
| | signal. |
| | Wavelet Wave: Wavelet Wave bands represent haptic effects |
| | encoded with wavelet transform decomposition, quantization, |
| | binary tree structure, and entropy coding |
| | Clause 6.10 details precisely how the data contained in |
| | keyframes is interpreted depending on the type of bands. |
| curve type | Present only for Curve bands. This specifies the interpolation |
| | method that shall be used to synthetize the haptic signal of the |
| | band. Possible values are: |
| | Linear |
| | Cubic |
| | Akima |
| | Bezier |
| | BSpline |
| | Unknown (for application specific functions) |
| block | This property is only present for Wavelet Wave bands. It is |
| length | the duration of a wavelet block. |
| lower | Lower frequency limit of the band (Hz). |
| frequency | |
| limit | |
| upper | Upper frequency limit of the band (Hz). |
| frequency | |
| limit | |
| effects | List of Haptic effects as defined in 6.9. |
| | If the effect list is empty, the band does not contain haptic |
| | data. |

Table 8 illustrates example perception modalities and corresponding units.

TABLE 8

| Modality | Perception unit | Unit |
|---|---|---|
| Pressure | Pa | S |
| Acceleration | m/s² | s |
| Velocity | m/s | s |
| Position | M | s |
| Temperature | K | s |
| Vibrotactile | Normalized to −1/1 | s |
| Water | m³ | S |
| Wind | m/s | S |
| Force | N | S |
| Electrotactile | Normalized to −1/1 | S |
| Vibrotactile Texture | Normalized to −1/1 | M |
| Stiffness | N | M |
| Friction | Normalized to −1/1 | M |
| Other | Normalized to −1/1 | s |

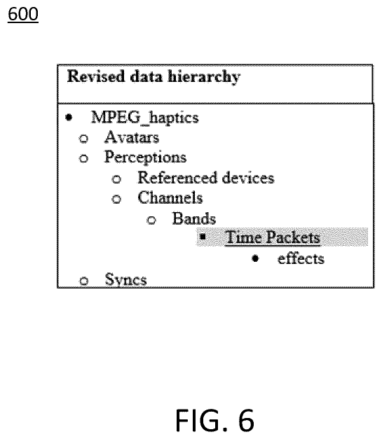

According to one or more embodiments, the haptics interchange format is modified to create a new level in the data hierarchy for the time packets. FIG. 6 illustrates an example data hierarchy with the “Time Packets” level added.

As illustrated in FIG. 6, in one or more examples, a band may include one or more time packets. Each time packet may have a parameter T that defines a temporal offset from the origin (e.g., the time of playback of the file). T can be in another parameter timescale, such that T/timescale defines the offset from the origin in seconds. In one or more examples, a time packet may also have only a duration value. In this case, the start of the packet is at the end of the previous packet. The duration shows the duration of the packet and may be in the scale of timescale.

In one or more examples, each time packet has one or more effects. The position of a temporal effect may indicate the offset of the effect from the start of the time packet. The position of the effect may be smaller than the duration of the packet.

The position of a spatial effect may indicate the spatial offset from a spatial origin. The effect may be rendered at the start time of the packet. In one or more examples, a packet with no effect (e.g., effect field blank or includes predetermined value indicating no effect such as NULL), may indicate a silent time in which no effect is needed to be rendered.

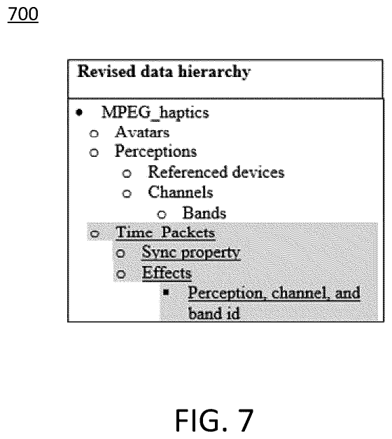

The embodiments of the present disclosure are further directed to a method for the live packetization of haptic effects in the haptic interchange format. According to one or more embodiments, a new data hierarchy for the time packets at a higher level. FIG. 7 illustrates an example data hierarchy 700 with the new additions underlined.

As illustrated in FIG. 7, the time packets may be an array at an avatar and perception levels. For example, the effect may refer to the perception, channel, and band by their id numbers. Each time packet may have a parameter T that defines the temporal offset from the origin (e.g., the time of playback of the file). T may be in another parameter timescale, such that T/timescale defines the offset from the origin in seconds. A time packet may also have only a duration value. In this case, the start of the packet is at the end of the previous packet. The duration may show the duration of the packet and may be in the scale of timescale. Each packet may also define whether it is a sync packet or not (e.g., packet synchronized a time point or spatial effect).

In one or more examples, each time packet has one or more effects. The position of a temporal effect may indicate the offset of the effect from the start of the time packet. The position of the effect may be smaller than the duration of the packet. The position of a spatial effect may indicate the spatial offset from a spatial origin. The effect is rendered at the start time of the packet.

In one or more examples, a packet with no effect (e.g., effect field blank or includes predetermined value indicating no effect such as NULL), may indicate a silent time in which no effect is needed to be rendered. The value of data hierarchy 700 is that new packets may be added to the files without the change in hierarchy. As a result, the new packets can be added to the packet array. This method is advantageous for live use cases, where the packets are gradually added to the end of the file in a live fashion.

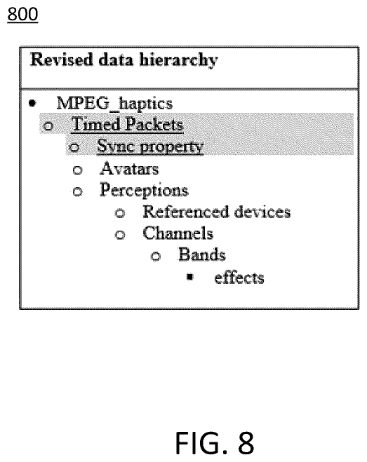

The embodiments of the present disclosure are further directed to a method for the serialization of HJIF files into time packets. According to one or more embodiments, a new level in the data hierarchy is created. FIG. 8 illustrates an example data hierarchy 800 with the new elements underlined.

As illustrated FIG. 8, besides the high-level information, all the information of an HJIF file is serialized into an array of timed packets. Each time packet may have a parameter T that defines the temporal offset from the origin (e.g., the time of playback of the file). T may be in another parameter timescale, such that T/timescale defines the offset from the origin in seconds. A time packet may also have only a duration value. In this case, the start of the packet is at the end of the previous packet. The duration may shows the duration of the packet and can be in the scale of timescale. Each packet may be a sync packet. This property may be signaled with the sync property of the packet.

Each time packet may have a duration of zero or more. A packet may have a start time. The start time and duration may be described in the scale of the parameter timescale. A zero-duration packet may have only metadata such as avatar or perception, reference devices, channels, and band information.

In one or more examples, the nonzero duration packets have one or more effects. The position of a temporal effect indicates the offset of the effect from the start of the time packet. The position of the effect may be smaller than the duration of the packet. The position of a spatial effect may indicate the spatial offset from a spatial origin. The effect may be rendered at the start time of the packet.

In one or more examples, a packet with no effect (e.g., effect field blank or includes predetermined value indicating no effect such as NULL), may indicate a silent time in which no effect is needed to be rendered.

The time-triggered spatial effects has significantly advantageous benefits including: (i) a spatial effect appearing at a certain time; and (ii) the spatial effect can be updated in time, e.g., an effect can potentially overwrite previous effects in the same position. Therefore, the spatial effects may be time-varying.

The timed packetized effect in the HJIF file provides significantly advantageous benefits including: (i) dividing the HJIF file into a series of packets where each packet has several effects; (ii) including stream friendly features, as each packet contains the time serialization of effects in packets; (iii) efficient rendering since the renderer starts rendering packet by packet, and does not need to read the entire JSON file and process it; and (iv) allowing timed-trigger spatial effects, where a spatial effect can be signaled to be triggered at a certain time.

The time serialization of the HJIF file includes significantly advantageous features including: (i) the file consists of a series of packets and therefore, it is straightforward to convert the file to MIHS streams; (ii) the renderer can read the time packet headers and only decode and render the desired packets and thus, the decoder does not need to read the entire HJIF file; (iii) the high-level metadata information such as perception, reference devices, avatar, and channel composition can be updated at any packet; (iv) live generation of the HJIF file is possible since each time packet can be added to the file, including updating the high-level metadata.

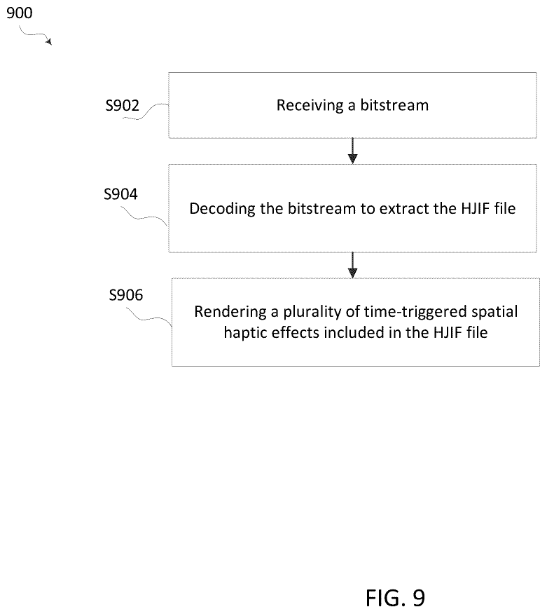

FIG. 9 illustrates a flowchart of an example process 900 for rendering time-triggered spatial haptic effects.

The process may start at operation S902 where a bitstream is received. The bitstream may be received by the decoder 350 (FIG. 4). The bitstream may be generated by the haptic encoder 300 (FIG. 3).

The process proceeds to operation S904 where the bitstream is decoded an HJIF file included in the bitstream. The HJIF file may define a plurality of time-triggered spatial haptic effects in accordance with Tables 1 and 2. Furthermore, the HJIF file may be defined and divided into a series of packets based on the data hierarchies illustrated in FIGS. 6-8.

The process proceeds to operation S906 where the plurality of time-triggered spatial haptic effects are rendered. The plurality of time-triggered spatial effects may be rendered by the renderer 380 (FIG. 4).

According to one or more embodiments a method includes creating a plurality of time-triggered spatial effects in a haptic exchanged format, wherein the time-triggered spatial effects are not static and dynamically variable with time, wherein each of the time-triggered spatial effects is associated with an additional parameter defining the respective trigger time of the each time-triggered spatial effect, wherein a renderer renders the plurality of time-triggered spatial effects, wherein the each time-triggered spatial effect is updatable in time by introducing additional new trigger times, thereby allowing a second time-triggered spatial effect overwriting a first time-triggered spatial effect and replacing its previous effect.

According to one or more embodiments, a method includes creating a time-packetized effect in haptic interchange format, wherein a new level of time packetization is used in a data hierarchy, wherein a band comprising one or more time packets, each packet including one or more of a starting time, a duration and a timescale, wherein packet information indicates time interval of the time packets, wherein each packet further includes one or more effects which is active through the duration of the time packet, wherein an empty packet corresponds to silent durations, wherein a spatial effect and/or a temporal effect is referenced using the packet start time, wherein the file is adapted to streaming, and wherein a renderer reads each packet in order and renders the each packet, thereby eliminating the need for renderer to read an entire file altogether.

According to one or more embodiments, a method includes creating a time-packetized haptic interchange format for live use cases, wherein a second and new data hierarchy for time packetization is used separately from a first data hierarchy, wherein each time packet includes a starting time, a duration and/or a timescale, wherein packet information includes a time interval of time packets, wherein each packet includes one or more effects which start in the duration of the each time packet, and each effect has references to corresponding perception, channel, and band identifiers, wherein an empty packet includes silent durations, wherein a spatial effect and/or a temporal effect is referenced using packet start times, wherein a HJIF file is adapted to streaming, and wherein a renderer reads the HJIF file via each packet sequentially and renders the HJIF file, thereby eliminating need for the renderer to read an entire HJIF file altogether.

According to one or more embodiments, a method includes generating time-serialization of a HJIF file in a haptic interchange format, wherein a series of timed packets comprise high-level file information, metadata and effect data, wherein the HJIF file includes an array of time packets, wherein the metadata and the effect data are added and/or updated at a respective packet, wherein the method further comprises creating live effects and adding the effects to an existing file, wherein a renderer navigates through the HJIF file by reading the packet's high-level data, parsing and decoding a selected portion of packets without parsing other packets.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of signaling a haptic java script object notation (JSON) interchange file format (HJIF) file, the method comprising:
processing the HJIF file into a binary file format for distribution in a bitstream,
wherein the HJIF file comprises a plurality of time-triggered spatial haptic effects,
wherein at least one time-triggered spatial haptic effect from the plurality of special haptic effects varies along a spatial axis,
wherein the at least one time-triggered spatial haptic effect is associated with a first parameter defining a trigger time, and
wherein a renderer is configured to render at least one time-triggered spatial haptic effect in accordance with the trigger time.

2. The method according to claim 1, wherein the at least one time triggered spatial effect is associated with a second parameter that indicates a distance from an origin for spatial perception of the at least one time-triggered spatial haptic effect.

3. The method according to claim 1, wherein the trigger time is an offset from a playback start time.

4. The method according to claim 1, wherein the trigger time is a time interval indicating a duration of the at least one time-triggered spatial haptic effect.

5. The method according to claim 1, wherein the plurality of time-triggered spatial haptic effects comprise another time-triggered spatial haptic effect that is rendered at a same position as the at least one time-triggered spatial haptic effect.

6. The method according to claim 5, wherein the another time-triggered spatial haptic effect is associated with another trigger time such that the another time-triggered spatial haptic effect is rendered after the at least one time-triggered spatial haptic effect.

7. A method of signaling a haptic java script object notation (JSON) interchange file format (HJIF) file, the method comprising:
processing the HJIF file into a binary file format for distribution in a bitstream,
wherein the HJIF file comprises a data hierarchy that specifies (i) a haptic perception at first level of the data hierarchy, (ii) one or more haptic channels corresponding to the haptic perception at a second level of the data hierarchy, and (iii) one or more haptic bands corresponding to the one or more haptic channels at a third level of the data hierarchy,
wherein the first level in the data hierarchy is higher than the second level in the data hierarchy, and the second level in the data hierarchy is higher than the third level in the data hierarchy
wherein the HJIF file further comprises a plurality time packets,
wherein each time packet comprises a time parameter and one or more haptic effects, and
wherein a renderer is configured to render each of the one or more haptic effects in accordance with the time parameter of each time packet.

8. The method according to claim 7, wherein the plurality of time packets correspond to the one or more haptic bands at a fourth level of the data hierarchy.

9. The method according to claim 8, wherein the fourth level of the data hierarchy is below the third level of the data hierarchy.

10. The method according to claim 8, wherein the fourth level of the data hierarchy is above the first level of the data hierarchy.

11. The method according to claim 7, wherein the plurality of time packets correspond to the first level of the data hierarchy, wherein each of the one or more haptic effects of each time packet is associated with a first ID corresponding the haptic perception, a second ID corresponding to the one or more haptic channels, and a third ID corresponding to the one or more haptic bands.

12. The method according to claim 7, wherein the time parameter of each packet specifies a temporal offset from an origin.

13. The method according to claim 7, wherein the time parameter of each packet specifies a duration value in which a starting time of a first time packet from the plurality of packets corresponds to an end time of a second time packet from the plurality of packets.

14. The method according to claim 7, wherein each time packet comprises a sync parameter indicating whether a respective time packet is a start of a new perception or a continuation of a previous perception.

15. The method according to claim 7, wherein the plurality of time packets further comprise at least one time packet with no effect indicating a silent time.

16. A method of decoding a haptic java script object notation (JSON) interchange file format (HJIF) file, the method comprising:
receiving a bitstream;
decoding the bitstream to extract the HJIF file; and
rendering a plurality of time-triggered spatial haptic effects included in the HJIF file,
wherein at least one time-triggered spatial haptic effect from the plurality of special haptic effects varies along a spatial axis,
wherein the at least one time-triggered spatial haptic effect is associated with a first parameter defining a trigger time, and
wherein the at least one time-triggered spatial haptic effect is rendered in accordance with the trigger time.

17. The method according to claim 16, wherein the at least one time triggered spatial effect is associated with a second parameter that indicates a distance from an origin for spatial perception of the at least one time-triggered spatial haptic effect.

18. The method according to claim 16, wherein the trigger time is an offset from a playback start time.

19. The method according to claim 16, wherein the trigger time is a time interval indicating a duration of the at least one time-triggered spatial haptic effect.

20. The method according to claim 16, wherein the plurality of time-triggered spatial haptic effects comprise another time-triggered spatial haptic effect that is rendered at a same position as the at least one time-triggered spatial haptic effect.
